(19) United States
(12) Patent Application Publication
(10) Pub. No.: US 2006/0164392 A1
(43) Pub. Date: Jul. 27, 2006

(54) Integrated mouse and the keyboard device

(76) Inventor: Chaokuo Mao, Taipei (TW)

Correspondence Address: BACON & THOMAS, PLLC, 625 SLATERS LANE, FOURTH FLOOR, ALEXANDRIA, VA, 22314, US

(21) Appl. No.: 11/038,148

(22) Filed: Jan. 21, 2005

(51) Int. Cl. G09G 5/08

(52) U.S. Cl. 345/163

(57) ABSTRACT

An integrated mouse and the keyboard device comprises a hand-held part having 5 buttons for hand holding; a moving part which can detect the rotation angle and moving range of user's palm; a stationary part placed under the user's forearm; a circuitry to convert the status of the said buttons, the rotation angle and moving range of the said moving part into electric signals; and an output control unit to convert the said electric signals received from the said circuitry into keyboard typing, mouse movement, or mouse button clicking signals, and then pass the said signals to the computer. This design enables the user to harness the cursor and the keyboard as freely as he wishes without having to change his usual habit, no matter he is in a sitting, standing, or lying position.

### BACKGROUND OF THE PRESENT INVENTION

1. Field of the Present Invention

The present invention relates to an input device, and more particularly it pertains to an integrated mouse and the keyboard device enabling the user to harness the cursor and the keyboard as freely as he wishes without having to change his usual habit, no matter he is in a sitting, standing, or lying position.

2. Description of the Related Art

With the development of science and technology and popularization of the computer, input devices have played an important role around our life. They are necessary for many electronic equipment such as computers, PDAs, and satellite control systems.

There are many kinds of mice and keyboards today, such as wired type, wireless type, industrial type, and ergonomics type. But no matter what have been improved, there is still the last restriction that both of them need a flat desk to work on. Besides, combining both of them is still a dream today. What people can do today is to combine both of them only by setting tracker ball on the rest part of keyboard, or by replacing mouse with touch pad.

The operation methods of all kinds of mouse and keyboard are almost same. All of them need a flat plane to operate, even for wireless mouse or keyboard. In this situation, users have to keep the posture of the arm. Users will get tired easily and harm the muscle of their arms easily for a long time.

Moreover, typing needs both hands to operate, but the mouse needs one more hand again. Besides, the keyboard has digital districts to operate. In conclusion, four hands are needed while operating the computer and it is not ergonomics. This is why most multimedia and appearance designers who work for a long time always suffer from the disease that the arm acid aches and even most of them need ability normal running of auxiliary equipment.

The most ideal situation is that users can operate mouse and keyboard at the same time with one hand and do something else with the other hand, (maybe hold a baby). Users with one single can operate computers without any inconvenience.

In addition, keys of the keyboard are still too many, so even the most experienced typing master may need to bow the head to have a look at the keyboard. It is more difficult to change and catch the mouse to come back without changing the sight.

### SUMMARY OF THE PRESENT INVENTION

In order to overcome the said defects described above, an object of the present invention is to provide an integrated mouse and keyboard device in which the mouse and keyboard can be truly integrated into one single device. The present invention enables the user to harness the cursor and the keyboard as freely as he wishes without having to change his usual habit, no matter whether he is in a sitting, standing, or lying position. The present invention is power saving, convenient, and space-less.

The best input device is to be equipped on user's hand, not put on the desk (It will keep the posture of hand and arm for a long time). For analyzing the motion of the keyboard and mouse, we can find that the they are similar. It means that the motion of moving and pressing for keyboard and mouse are similar. From the above viewpoints, we have chance to integrate keyboard and mouse successfully if we find the convenient operation for the hand.

According to the pressing of the fingers, the degree of raising or stretching of the palm, the rotation angle of the palm while users type the keyboard or control the mouse, the present invention integrating the mouse and keyboard devices can decide which button has been pressed or what position the mouse moves to by detecting the three states of motion mentioned above. The related position (for user's hand) of the mouse and the keyboard is fixed between the forearm and palm within any situation or posture. It seems that the keyboard and mouse is always following the hand so that user can input with his/her hand raised, stretched, or descended.

The present invention is not only integrating mouse and the keyboard, but also can be operating without change user's habit.

These and other objects, features and advantages of the present invention will become more apparent from the following description and the appended claims, taken in connection with the accompanying drawings in which preferred embodiment of the present invention are shown by way of illustrative examples.

### DETAILED DESCRIPTION OF THE PREFERRED EMBODIMENT

Please refer to FIG. 1, FIG. 1 shows the structure of an embodiment of the present invention. The present invention Integrated Mouse and Keyboard Device comprises a hand-held part 10 for hand (A) holding. A button can be pressed by user's thumb is set on one site of the said hand-held part 10. Upon the front end of the said hand-held part 10 one or several rows of buttons (13) are set, with each row having 4 buttons. A moving part 20 is made of soft flexible board. On the front end of the said moving part 20 is a pivot 21, on which the said hand-held part 10 may rest and turn, and also on/inside said pivot 21 an angle detector 14 may be set to detect the rotation range of said hand-held part 10. A stationary part 30 is made of solid board and placed under the user's forearm D (the part between the wrist B and the elbow C). The front end of the said stationary part 30 is connected with the said moving part 20, and a movement detector 32 is set on the said stationary part 30 to measure the moving range of the said moving part 30. A circuitry 40 is to convert the status of the said button 13, the rotation angle, and the moving range of the said moving part 20, into electric signals. An output control unit 50 is to convert the said electric signals received from the said circuitry 40, into keyboard typing, mouse movement, or mouse button signals Then pass the generated said signals to the computer.

Please refer to FIG. 2A, FIG. 2A shows the said embodiment of the present invention is held by hand. The five buttons 13 of the hand-held part 10 are used to detect the pressing and clicking of the user's fingers. The said angle detector 14 (between the said moving part 20 and the said hand-held part 10) is used to detect the moving range of the user's palm A in relation to the forearm D. The said movement detector 32 (between the said moving part 20 and the said stationary part 30) is used to detect the range/extent which the user raises or presses his/her forearm upon the stationary part 30. By this design the user can control the computer freely and easily as he wishes without having to change his usual habit, no matter whether he is in a sitting, standing, or lying position.

The front end of the said hand-held part 10 and the said hand-held part 10 together form a smooth-curved surface and a plurality of finger loop 131 may be set on the front end of the said hand-held part (close to the button 13) to prevent the said hand-held part from slipping off the user's fingers. Finger loop 131 can be designed for each one finger loop to correspond to one finger, or designed as a thumb loop (holding the thumb) and a four-finger loop (holding the index finger, the middle finger, the ring finger, and the little finger together), shown by FIG. 2B. An arm loop 33 may be set on the said stationary part 30 to prevent the said stationary part from slipping off.

The present invention integrates the keyboard and mouse so that pressing the buttons 13 is equivalent to pressing the buttons of keyboard or the buttons of mouse. Swinging the hand is equivalent to typing moves (horizontal) or mouse moves (horizontal). Raising or stretching the hand is equivalent to pressing the front buttons (on the contrary the backward buttons) or moving the mouse forward and backward.

(change line) The present invention has two operation modes, one is keyboard mode and the other is mouse mode. The present invention can recognize which mode the user is using by many methods, such as setting a switch for the user to change mode, or providing a predefined button to trigger. For example, pressing five buttons is also an approach. There are still many methods exiting, one method is to stretch five fingers at the same time to change the current mode. It means that a predetermined motion of hand (palm, or fingers, or both) can trigger the present invention to change its mode. Besides, several other modes can be designed for convenience, including left-hand keyboard mode, right-hand keyboard mode, and digital button mode.

The present invention is to correspond the current keyboard to ten fingers (dual hand typing mode). It also can be designed as to operate with only one hand (one hand typing mode). Besides, the present invention can be designed to transfer one or several buttons, which correspond to disabled fingers. The above design is independent of the hardware and it can be accomplished by the signal handling design for the output control unit 50.

Similarly, users can operate any specific virtual keyboard (for example, a big keyboard which contains both the English buttons and double-byte character buttons), by changing the design of the output control unit 50.

The structure mentioned above is an embodiment of the present invention. It may still be changed within the scope of the present invention. For example, the said output control unit 50 can be simulated by computer software. Furthermore, the said output control unit 50 can be integrated with current mouse driver, so that many functions such as absolute coordinate controlling can also be included. Besides, the hand-held part 10 also can be integrated with current mouse such as the scrolling wheel or the speed change switch.

For operating convenience, the pulling springs are loaded between the said stationary part 30 and the said moving part 20 to help the said moving part 30 move back in position.

The said stationary part 30 is shaped as a flat case with an open end and wherein rear section of the said moving part 20 is placed and can move freely within.

It is important that the said moving part 20 and the stationary part 30 compose an elastic structure. The elastic structure also can be accomplished by another method.

The said movement detector 32 between the said stationary part 30 and the said moving part 20 can be an ultrasonic distance detector, with the transmitter and receiver of the ultrasonic distance detector placed on the rear end of the said stationary part 30 and the said moving part 20 respectively.

Besides, the said movement detector 32, between the said stationary part 30 and the said moving part 20, can be an electric resistance detecting type distance detecting device, which can be effected by setting a conductive rod on the interior of the said stationary part 30, so that distance between the two rear ends of the said stationary part 30 and the said moving part 20 can be detected by measuring the resistance value of the said conductive rod.

Please refer to FIG. 3, FIG. 3A-3C show the structure viewed from the back and the top of the pivot part of the said embodiment of the present invention. To combine the hand-held part 10 and the moving part 20, a round hole 15 is designed in the rear end of the said hand-held part 10 to fit the said pivot 21 with the said stationary part 20. There are many kinds of the structure of the pivot part 21. Two of them are easily to carry out:

One of them is that the said pivot 21 has one or several protrusions 211 on its outer periphery to prevent it from slipping off the said hand-held part 10. Please refer to FIG. 3 A.

The other kind is that the said pivot 21 tapers from top to bottom to prevent it from slipping off the said hand-held part 10. Please refer to FIG. 3 B.

The present invention combines the hand-held part 10 and the moving part 20 by setting the pivot 21. For the purpose of combination, the said pivot 21 can also be set on the bottom of the hand-held part 10 and the round hole is set on the moving part 20. The said pivot 21 can be a structure incorporating bearings, with the said bearings being set on either the said hand-held part 10 or the said moving part 20.

Please refer to FIG. 3C, the angle detector 14 of the present invention between the hand-held part 10 and the moving part 20 can be made of optical grating 22, which can be effected by placing an optical grating 22 surround the said pivot 21, by placing a light transmitter 213 on one site of the said pivot 21, and by placing a light receiver 214 on the opposite side. Within this design, the light receiver 214 will receive the flashing signals from the light transmitter 213 through the optical grating 22 while the hand-held part 10 is rotating relative to the moving part 20. The degree of the above rotation can be calculated this way. Besides, a tracker ball and a tracker ball detecting device can also achieve the above purpose. The said angle detector can be set on either the said hand-held part or the said moving part.

Please refer to FIG. 4, FIG. 5, FIG. 6, and FIG. 7. They are outlook view, side view, rear view, and front view of the present invention, respectively. FIG. 4A shows the outlook of one type embodiment of the present invention (with one single row of buttons), and FIG. 4B shows the outlook of another type embodiment (with multiple rows of buttons). For example, three rows of buttons corresponding to the three rows of keys on a typical keyboard are set on the front end of the said hand-held part 10. With this design, the user can type English characters easily without raising or drooping his/her palm.

Please refer to FIG. 8, FIG. 9, and FIG. 10. They show how the said embodiment of the present invention is used. The present invention is usually at the state as FIG. 8 while being operated.

The palm will lean to front and down when pressing the upper buttons of keyboard or moving the mouse forward. At this time, the moving part 20 will trend to back into stationary part 30. Please refer to the bold arrow in FIG. 9. On the contrary, the palm will lean to back and up when pressing the lower buttons of keyboard or moving the mouse backward. At this time, the moving part 20 will trend to leave away stationary part 30. Please refer to the thin arrow in FIG. 9.

The pivot part 21 will turn left when pressing the left buttons of keyboard or moving the mouse left, please refer to the bold arrow in FIG. 10. On the contrary, the pivot part 21 will turn right when pressing the right buttons of keyboard or moving the mouse right. Please refer to the thin arrow in FIG. 10.

Please refer to FIG. 11, an elastic strap 60 may be added to connect the said finger loops 131 and the said arm loop 33 together to help offset gravity and ease the raising and moving around of the user's hand. The elastic strap 60, the said finger loops 131, and the said arm loop 33 may be made/produced/manufactured as a one-piece object.

There are many kinds of devices can be integrated in the present invention. For example, a laser beam device can be added on the said hand-held part. Besides, a display screen can be added onto the said hand-held part to tell the user where (on which row of the keyboard) his current position is.

Using Ctrl-Space or Ctrl-Shift to switch into English mode or double-type character mode always make users difficult to type and tend to forget the current mode. The degree of raising and swinging of the palm can be very wide, which may even provide a bigger keyboard than the current one. With the present invention, a bigger keyboard having all English buttons and the components of double-type character buttons can be simulated for this purpose.

There are advanced applications for the present invention. For example, we can design software to record the data, which the user has typed by using the present invention so far. The data will be listed in the order of by frequency so that the user can choose them for faster typing.

The present invention also can be integrated with other electronic devices which are not mentioned above by wired or wireless method. For example, the present invention can be integrated with electronic KVM or mechanical KVM. The other advanced functions can be included. By applying to KVM, a computer pointing device can be set on the present invention so that it can tell users which computer is being controlled. The said computer pointing device can be accomplished by light or alarm. Besides, it is possible to control the KVM through the present invention.

The position of the angle detector and movement detector is not limited as mentioned above. Besides, the present invention can transfer the signal to computer either by wired mode or wireless mode.

A scroll wheel can be set on the said hand-held part to scroll windows up and down or to scroll windows from left to right. The wheel can also be replaced by buttons or keys.

While the present invention has been described with reference to the illustrative embodiment, this description is not intended to be construed in a limited sense. Various modifications of the illustrative embodiment of the present invention, such as the set laser beam device, the position of the optical grating, the kind of elastic strap, the number of buttons and rows of the hand-held part, the kinds of the angle detector and movement detector, will be apparent to those skilled in the art with reference to this description. It is therefore completed and the appended claims will cover any such modifications or embodiments falling within the true scope of the present invention.

### BRIEF DESCRIPTION OF THE DRAWINGS

FIG. 1 shows the structure of an embodiment of the present invention: Integrated Mouse and Keyboard Device.

FIG. 2A shows how (one type) the said embodiment of the present invention is held by hand. (one thumb loop with four finger loops)

FIG. 2B shows how (another type) the said embodiment of the present invention is held by hand. (one thumb loop with one palm loop)

FIG. 3A-3C show the structure viewed from the back and the top of the pivot part of the said embodiment of the present invention.

FIG. 4A shows the outlook of one type embodiment of the present invention.

FIG. 4B shows the outlook of another type embodiment (with multiple rows of buttons) of the present invention.

FIG. 5 shows the side view of the said embodiment of the present invention.

FIG. 6 shows the rear view of the said embodiment of the present invention.

FIG. 7 shows the front view of the said embodiment of the present invention.

FIG. 8, FIG. 9 & FIG. 10 show how one type of the said embodiment of the present invention is used.

FIG. 11 show how the said embodiment of the present invention is used with an additional elastic strap.

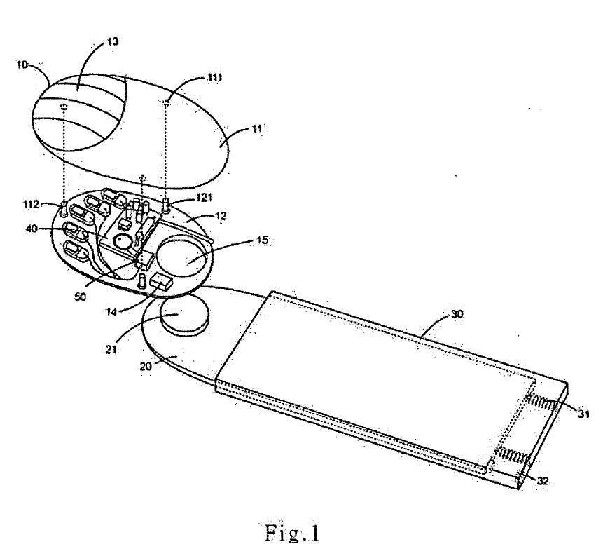

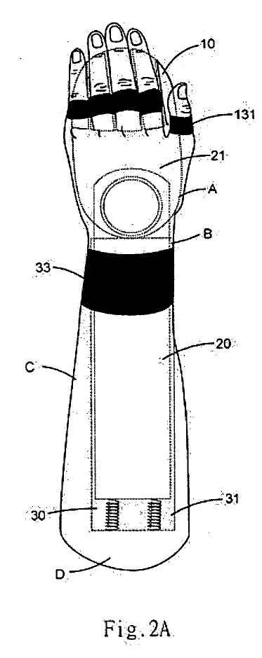

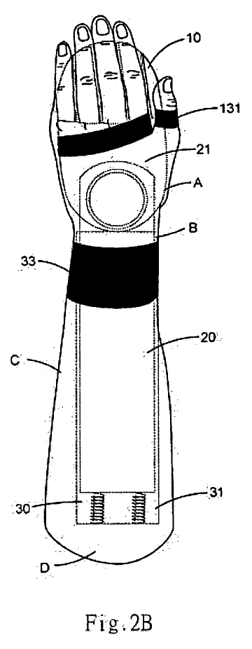

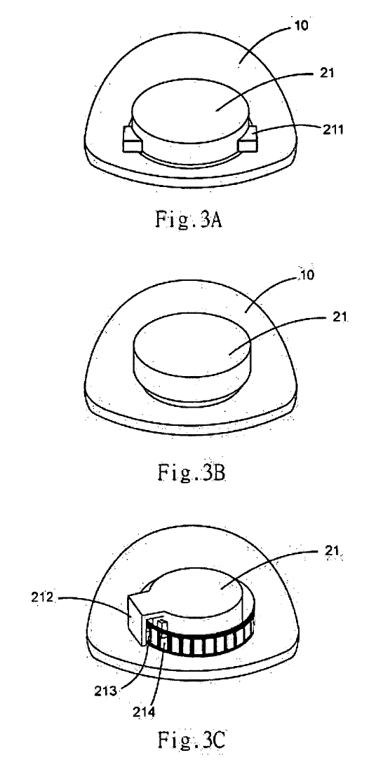

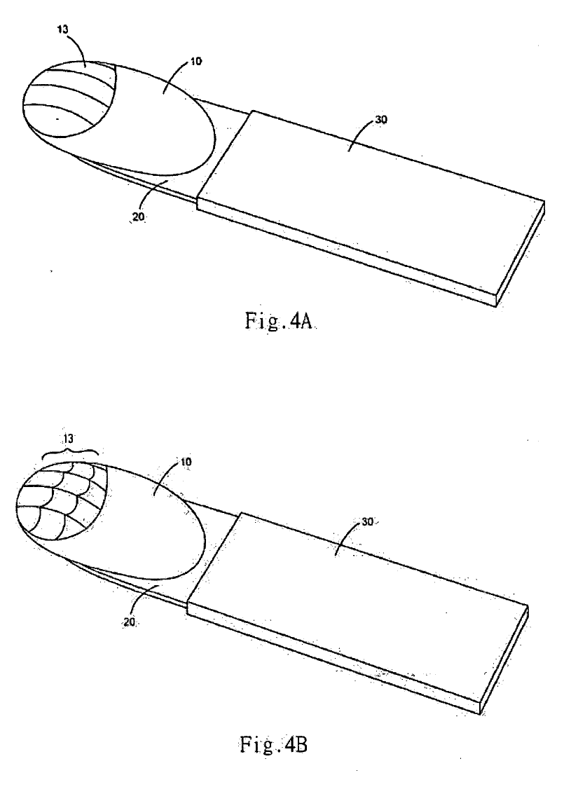

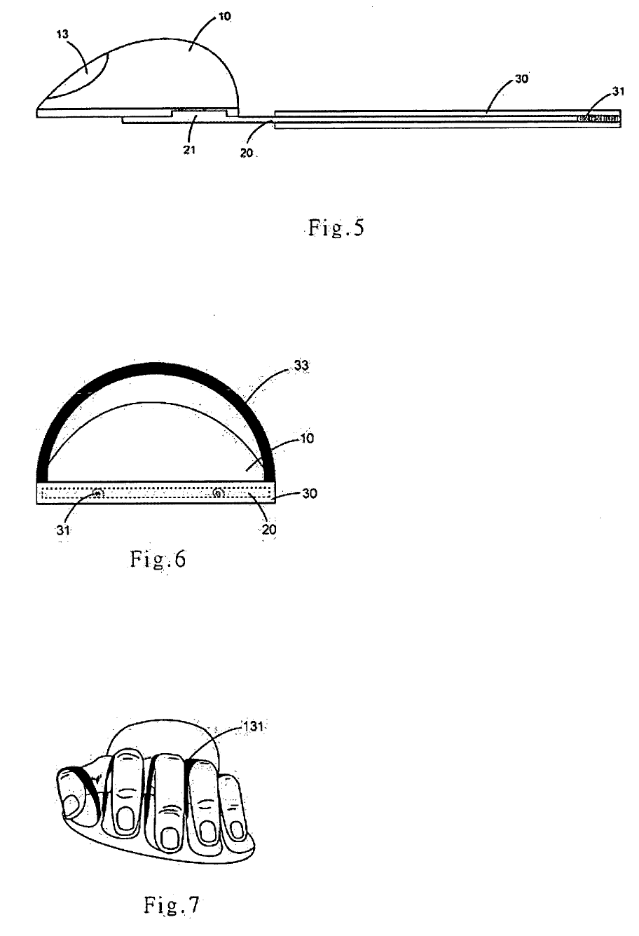

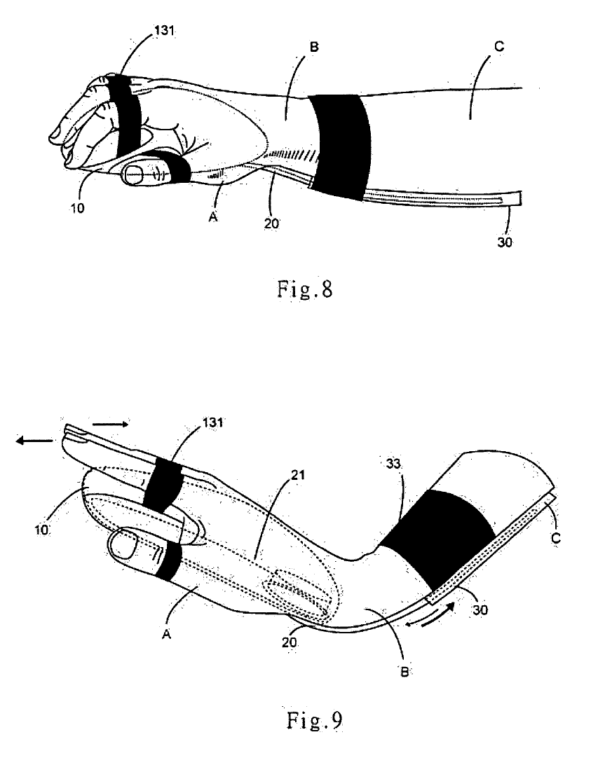

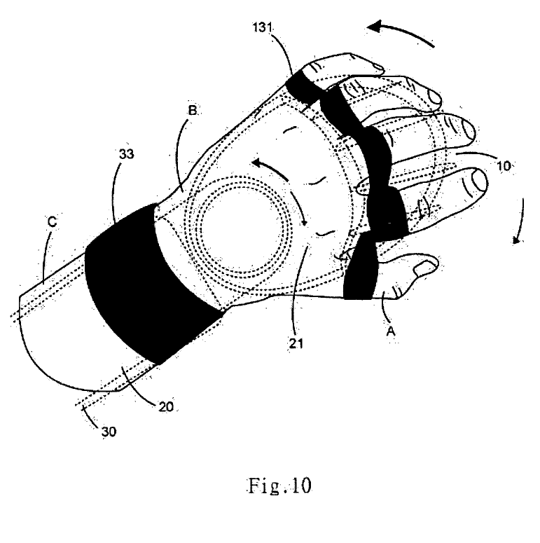

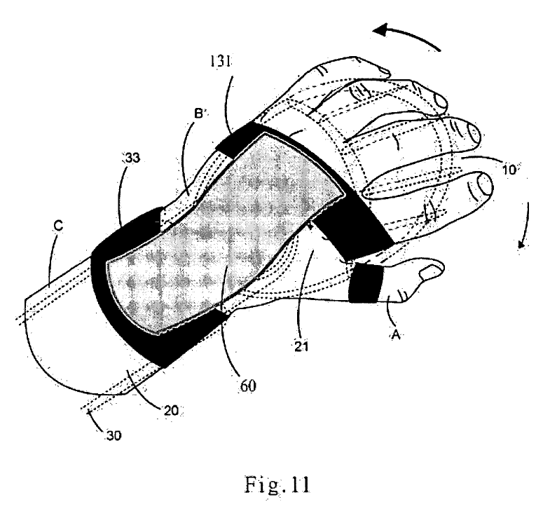

What is claimed is:

1. An integrated mouse and the keyboard device comprises:
a hand-held part for hand holding; upon the front end of which one or several rows of buttons are set, with each row having 4 buttons;
a moving part made of soft flexible board; on the front end of the said moving part is a pivot on which the said hand-held part may rest and turn, and also on/inside the said pivot an angle detector may be set to detect the rotation range of the said hand-held part;
a stationary part made of solid board and placed under the user's forearm (the part between the wrist and the elbow); the front end of the said stationary part is connected with the said moving part, and a movement detector is set on the said stationary part to measure the moving range of the said moving part;
a circuitry to convert the status of the said buttons, the rotation angle and moving range of the said moving part into electric signals; and
an output control unit to convert the said electric signals received from the said circuitry into keyboard typing, mouse movement, or mouse button clicking signals, and then pass the said signals to the computer;
and wherein:
the said buttons on the said hand-held part are used to detect the pressing and clicking of the user's fingers on the said buttons; and
the said angle detector (between the said moving part and the said hand-held part) is used to detect the moving range of the user's palm relative to the forearm; and
the said movement detector (between the said moving part and the said stationary part) is used to detect the range/extent the user raises or presses his/her forearm upon the stationary part.

2. An integrated mouse and the keyboard device as in claim 1, wherein the said output control unit can be replaced by computer software.

3. An integrated mouse and the keyboard device as in claim 1, wherein the front end of the said hand-held part and the said hand-held part together form a smooth-curved surface.

4. An integrated mouse and the keyboard device as in claim 1, wherein a plurality of finger loops may be set on the front end of the said hand-held part to prevent the said hand-held part from slipping off the user's fingers.

5. An integrated mouse and the keyboard device as in claim 3, wherein a plurality of finger loops may be set on the front end of the said hand-held part to prevent the said hand-held part from slipping off the user's fingers.

6. An integrated mouse and the keyboard device as in claim 1, wherein an arm loop may be set on the said stationary part to prevent the said stationary part from slipping off.

7. An integrated mouse and the keyboard device as in claim 1, wherein the user can switch between keyboard mode and mouse mode via a switch (on the said hand-held part) that transmits control signals to the said output control unit to tell whether the user is sending a keyboard or mouse signal.

8. An integrated mouse and the keyboard device as in claim 1, wherein the user can switch between keyboard and mouse mode by a predetermined motion of hand (palm, or fingers, or both) that transmits signals to the said output control unit to tell whether the user is sending a keyboard or mouse signal.

9. An integrated mouse and the keyboard device as in claim 1, wherein the said output control unit can be set in either one hand typing mode or two hand typing mode.

10. An integrated mouse and the keyboard device as in claim 1, wherein the said output control unit can integrate all kinds of mouse driver.

11. An integrated mouse and the keyboard device as in claim 1, wherein pulling springs are loaded between the said stationary part and the said moving part to aid setting the said moving part back in position.

12. An integrated mouse and the keyboard device as in claim 1, wherein the said stationary part is shaped like a flat case with an open end and wherein rear section of the said moving part is placed and can move freely within.

13. An integrated mouse and the keyboard device as in claim 1, wherein the said movement detector between the said stationary part and the said moving part can be an ultrasonic distance detector, with the transmitter and receiver of the ultrasonic distance detector placed on the rear end of the said stationary part and the said moving part respectively.

14. An integrated mouse and the keyboard device as in claim 1, wherein the said movement detector between the said stationary part and the said moving part can be an electric resistance detecting type distance detecting device, which can be effected by setting a conductive rod on one inner site of the said stationary part that distance between the two rear ends of the said stationary part and the said moving part can be detected by measuring the resistance value of the said conductive rod.

15. An integrated mouse and the keyboard device as in claim 1, wherein the said angle detector between the said hand-held part and the said moving part can be made of optical grating, which can be effected by placing an optical grating surround the said pivot and placing a light transmitter on one site of the said pivot and placing a light receiver on the opposite side.

16. An integrated mouse and the keyboard device as in claim 1, wherein the said angle detector between the said hand-held part and the said moving part can be replace by a tracker ball and tracker ball detecting device.

17. An integrated mouse and the keyboard device as in claim 1, wherein a laser beam device can be added on the said hand-held part.

18. An integrated mouse and the keyboard device as in claim 1, wherein a displaying screen can be added onto the said hand-held part to tell the user where (on which row of the keyboard) his current position is.

19. An integrated mouse and the keyboard device as in claim 1, wherein the said angle detector can be set on either the said hand-held part or the said moving part.

20. An integrated mouse and the keyboard device as in claim 1, wherein there is a round hole in the rear end of the said hand-held part to fit the said pivot of the said stationary part.

21. An integrated mouse and the keyboard device as in claim 1, wherein the said pivot has one several protrusions on its outer periphery to prevent it from slipping off the said hand-held part.

22. An integrated mouse and the keyboard device as in claim 20, wherein the said pivot has one several protrusions on its outer periphery to prevent it from slipping off the said hand-held part.

23. An integrated mouse and the keyboard device as in claim 1, wherein the said pivot tapers from top to bottom to prevent it from slipping off the said hand-held part.

24. An integrated mouse and the keyboard device as in claim 20, wherein the said pivot tapers from top to bottom to prevent it from slipping off the said hand-held part.

25. An integrated mouse and the keyboard device as in claim 1, wherein the said pivot can be a structure incorporating bearings, with the said bearings being set on either the said hand-held part or the said moving part.

26. An integrated mouse and the keyboard device as in claim 1, wherein the said movement detector can be set on either the said moving part or the said stationary part.

27. An integrated mouse and the keyboard device as in claim 1, wherein a wireless transmitting device can be added to transmit signals to the computer in wireless mode.

28. An integrated mouse and the keyboard device as in claim 1, wherein one or several buttons can be set on the said hand-held part, with each button or a plurality of buttons corresponding to one or several frequently-used keys.

29. An integrated mouse and the keyboard device as in claim 1, wherein a scroll wheel can be set on the said hand-held part to scroll windows up and down.

30. An integrated mouse and the keyboard device as in claim 1, wherein a scroll wheel can be set on the said hand-held part to scroll windows from left to right and vice versa.

31. An integrated mouse and the keyboard device as in claim 1, wherein a scroll button/key can be set on the said hand-held part to scroll windows up and down.

32. An integrated mouse and the keyboard device as in claim 1, wherein a scroll button/key can be set on the said hand-held part to scroll windows from left to right and vice versa.

33. An integrated mouse and the keyboard device as in claim 1, wherein three rows of buttons corresponding to the three rows of keys on a typical keyboard are set on the front end of the said hand-held part.

34. An integrated mouse and the keyboard device as in claim 1, wherein several rows of buttons corresponding to several rows of keys on a typical keyboard are set on the front end of the said hand-held part.

35. An integrated mouse and the keyboard device as in claim 1, wherein the number of the said buttons on the front end of the said hand-held part is not necessarily five on each row.

36. An integrated mouse and the keyboard device as in claim 33, wherein the number of the said buttons on the front end of the said hand-held part is not necessarily five on each row.

37. An integrated mouse and the keyboard device as in claim 34, wherein the number of the said buttons on the front end of the said hand-held part is not necessarily five on each row.

38. An integrated mouse and the keyboard device as in claim 4, wherein a thumb loop (holding the thumb) and a four-finger loop (holding the index finger, the middle finger, the ring finger, and the little finger together) may be set on the front end of the said hand-held part to prevent the said hand-held part from slipping off the user's hand.

39. An integrated mouse and the keyboard device as in claim 4, wherein a plurality of finger loops may be set on the front end of the said hand-held part to prevent the said hand-held part from slipping off the user's fingers.

40. An integrated mouse and the keyboard device as in claim 1, wherein an elastic strap may be added to connect the said finger loops and the said arm loop together to help offset gravity and ease the raising and moving around of the user's hand.

41. An integrated mouse and the keyboard device as in claim 1, wherein the said elastic strap, the said finger loops, and the said arm loop may be made/produced/manufactured as a one-piece object.
